(19) United States
(12) Patent Application Publication
(10) Pub. No.: US 2026/0167832 A1
(43) Pub. Date: Jun. 18, 2026

(54) FLAME-RETARDANT COMPOSITION AND RELATED METHODS

(71) Applicant: CELESTIAL MATERIALS LLC, River Falls, WI (US)

(72) Inventor: Brian HANRAHAN, River Falls, WI (US)

(21) Appl. No.: 19/128,907

(22) PCT Filed: Nov. 10, 2023
(86) PCT No.: PCT/US2023/037135

§ 371 Date: May 9, 2025

Related U.S. Application Data
(60) Provisional application No. 63/383,223, filed on Nov. 10, 2022.

(51) Int. Cl. C09D 5/18; C04B 35/195; C04B 35/447; C04B 35/622; C08J 3/20; C08K 3/32; C08K 3/34; C09D 7/40; C09D 7/61; C09D 7/80

(52) U.S. Cl. CPC C09D 5/185; C04B 35/195; C04B 35/447; C04B 35/62222; C08J 3/203; C09D 7/61; C09D 7/69; C09D 7/80; C04B 2235/3481; C04B 2235/447; C08K 2003/321; C08K 2003/343; C08K 2201/005

(57) ABSTRACT

A flame-retardant composition comprising at least one solid phosphate salt and at least one acid soluble silicate material. The solid phosphate salt having a desired melting point, such that the solid phosphate salt is capable of melting at an elevated temperature, such as a fire, to react in situ with the acid soluble silicate material with minimal exothermic energy to form a ceramic flame-retardant material that provides a thermal insulation barrier. The flame-retardant composition can also comprise at least one polymer material that combusts or melts in the presence of the elevated temperature to enable melting of the solid phosphate salt. The flame-retardant composition can be provided in the form of a plastic article, such as a sheet of material, a paint formula, or an intumescent coating. The flame-retardant composition can be prepared by melt processing or high shear mixing at a temperature below the melting point of the solid phosphate salt.

### CLAIM TO PRIORITY

The application is a National Stage entry of PCT Application No. PCT/US2023/037135 filed Nov. 10, 2023, which claims priority to U.S. Provisional Application No. 63/383,223 filed Nov. 10, 2022, which is hereby incorporated by reference in its entirety.

### TECHNICAL FIELD

The present invention relates to a flame-retardant composition comprising a solid phosphate salt that is capable of melting to react with an acid soluble silicate material to form in situ a ceramic flame-retardant material that provides a thermal insulation barrier, particularly the flame-retardant composition provided in the form of a plastic article, a paint formula, or an intumescent coating. The present invention further relates to articles comprising the flame-retardant composition, methods of making the flame-retardant compositions, particularly melt processing or high shear mixing at a temperature below the melting point of the solid phosphate salt, and the resulting ceramic flame-retardant material formed in situ that is capable of providing a thermal insulation barrier.

### BACKGROUND

It is well-known in the art to produce flame-retardant polymer compositions for various functions. The flame-retardant may, for example, work by one or more of endothermic degradation, thermal shielding, dilution of gas phase and gas phase radical quenching. Flame-retardants that work by endothermic degradation remove heat from the substrate and thus cool the material. Flame-retardants that work by thermal shielding create a thermal insulation barrier between the burning and unburned parts of the material, for example by forming a char, which separates the flame from the material and slows heat transfer to the unburned material. Flame-retardants that work by dilution of the gas phase produce inert gases (e.g. carbon dioxide and/or water) by thermal degradation and thus dilute the combustible gases, thus lowering the partial pressures of the combustible gases and oxygen and slowing the reaction rate. Flame-retardants that work by gas phase radical quenching release substances such as hydrogen chloride and hydrogen bromide that react with H and OH radicals in the flame, forming less reactive radicals (e.g. CI and Br radicals), which have much lower potential to propagate the radical oxidation reactions.

There has been recent growth in flame-retardants that work by thermal shielding by using ammonium polyphosphate (APP), or another phosphate-chemistry, to react with an underlying carbonizing component, such as a cellulose material or by a chemical synergist, such as a nitrogen-containing compound added to a polymeric material. APP starts to decompose at 240° C. to form ammonia and phosphoric acid. The mechanism of reaction includes the phosphoric acid catalyzing a dehydration reaction of the carbonizing component, which ultimately releases carbon dioxide and yields char residues. In the gas phase, the release of non-flammable carbon dioxide helps dilute the oxygen of the air and flammable decomposition products of the material that is burning. In the condensed phase, the resultant carbonaceous char helps shield the underlying combustible material from attack by oxygen and radiant heat, such that the char residue is impenetrable to flame growth.

The requirements for the various flame-retardancy properties of a polymer composition may vary depending on the intended final use of the polymer composition, including, for example heat release, smoke production, vertical flame propagation, smoke density, smoke acidity, melt viscosity, stiffness and tensile strength. These properties may be affected by the additives that are included in the polymer composition to obtain the required flame-retardancy properties.

For instance, International Publication No. WO2018/187638 discloses a flame-retardant polymer composition comprising a polymer, a flame retardant, a high aspect ratio particulate mineral and optionally a reinforcing material, wherein the high aspect ratio particulate material comprising talc, mica, wallastonite, halloysite or a combination of one or more thereof replaced up to 10% glass fiber in the working examples that utilized the flame-retardant additive Exolit OP 1314 (aluminum diethyl phosphinate) from Clariant. The replacement of 10% glass fiber with the minerals slightly decreased stiffness compared to glass filled flame-retardant formulation, and did not affect HDT and had a positive effect on increasing melt flow.

The market has also observed an increasing interest in halogen free flame retardant additives to be used in the production of corresponding flame-retardant compositions. Some of the known halogen-free flame retardant additives mostly used in thermoplastic polymers include inorganic flame retardants like magnesium hydroxide, melamine derivatives, organic derivatives of phosphoric acid, red-phosphorous, organic phosphinates, and hypophosphorous acid metal salts. U.S. Patent Publication No. 2008/0033079 discloses a thermoplastic composition comprising aluminum hypophosphite (aluminum phosphinate) as a halogen-free flame retardant agent used with polyamide.

There remains a need in the industry for halogen-reduced or halogen-free compositions that maintain good mechanical properties while providing good flame-retardant properties. There is also a need for flame-retardant compositions that maintain high thermal stability during processing and a high degree of retention of mechanical properties, while providing significant flame-retardant properties. There further remains a need in the industry to reduce the use of toxic, hazardous and/or environmentally unfriendly components in flame-retardant compositions. Still further, there remains a need for flame-retardant compositions that do not rely upon a cellulose source or a nitrogen-containing synergist to react with the phosphate functionality to form a char layer. Moreover, there remains a need for a flame-retardant composition that can be utilized in a variety of flame-retardant vehicles, including plastics, paint formulas and/or intumescent coatings.

### SUMMARY

Various aspects of the present invention include flame-retardant compositions, methods of manufacturing flame-retardant compositions, methods of forming ceramic flame-retardant materials from the flame-retardant compositions, and articles of manufacture, paint formulas and intumescent coatings having the flame-retardant composition, which is capable of forming a ceramic flame-retardant material providing a thermal insulation barrier as a result of an elevated temperature or fire. The flame-retardant composition has a solid phosphate salt and an acid soluble silicate material, wherein the solid phosphate salt is non-reactive with the acid soluble silicate material at ambient temperature. But as a result of an elevated temperature and/or fire, at least a portion of the solid phosphate salt transforms into a melted or liquid form providing a reactive phosphate component that is capable of reacting in situ with the acid soluble silicate material to form a ceramic flame-retardant material providing a thermal insulation barrier. The flame-retardant composition optionally has a polymer substrate in which the solid phosphate salt and the acid soluble silicate material are dispersed.

In some aspects, a method of forming a ceramic flame-retardant material in situ to provide a thermal insulation barrier includes providing the flame-retardant composition having a solid phosphate salt, an acid soluble silicate material, and an optional polymer substrate, such that at least a portion of the solid phosphate salt decomposes or transforms into a reactive phosphate component at a desired elevated temperature and/or fire that reacts with the acid soluble silicate material to form the ceramic flame-retardant material.

In some preferred aspects, the flame-retardant composition can be provided as at least a portion of an article of manufacture, a paint formula applied to at least a portion of an article, or an intumescent coating applied to at least a portion of an article. In some preferred aspects, the solid phosphate salt and the acid soluble silicate material are dispersed within a polymer substrate defining the flame-retardant composition, which then can be provided as a plastic article of manufacture, a paint formula or an intumescent coating, such that the flame-retardant composition has flame-retardant properties in that it is capable of forming the ceramic flame-retardant material in situ as a result of an elevated temperature and/or fire.

In some preferred aspects, the flame-retardant composition is essentially free of an organic and/or nitrogen-based synergist typically used within in the industry to react with a reactive phosphate component, such as a phosphate melt and/or phosphoric acid.

In some preferred aspects, the acid soluble silicate material is an active synergist with the reactive phosphate component to form the ceramic flame-retardant material.

In some aspects, the solid phosphate salt comprises a sodium phosphate, a calcium phosphate, a potassium phosphate, an ammonium phosphate, a magnesium phosphate, a polyphosphate, a pyrophosphate, a metaphosphate.

In some aspects, the solid phosphate salt comprises one or more inorganic phosphate-type anion chosen from an orthophosphate anion (PO₄³⁻), a hydrogen phosphate anion (HPO₄²⁻), a dihydrogenphosphate anion (H₂PO₄⁻), a polyphosphate anion (P₂O₇⁴), a triphosphate anion (P₃O₁₀⁵), and mixtures thereof.

In some aspects, the solid phosphate salt comprises a calcium phosphate chosen from monocalcium phosphate (Ca(H₂PO₄)₂ and Ca(H₂PO₄)₂(H₂O)), dicalcium phosphate (CaHPO₄(H₂O)₂ and CaHPO₄(H₂O)), tricalcium phosphate (Ca₃(PO₄)₂), octacalcium phosphate (Ca₈H₂(PO₄)₆·5H₂O), dicalcium diphosphate (Ca₂P₃O₇), calcium triphosphate (Ca₅(P₃O₁₀)₂), hydroxyapatite (Ca₅(PO₄)₃(OH)), apatite (Ca₁₀(PO₄)₆(OH,F,Cl,Br)₂), tetracalcium phosphate (Ca₄(PO₄)₂O), and mixtures thereof.

In some aspects, the solid phosphate salt comprises a potassium phosphate chosen from monopotassium phosphate (KH₂PO₄), dipotassium phosphate (K₂HPO₄), tripotassium phosphate (K₃PO₄), and mixtures thereof.

In some aspects, the solid phosphate salt comprises a sodium phosphate chosen from monosodium phosphate (NaH₂PO₄, NaH₂PO₄(H₂O) and NaH₂PO₄(H₂O)₂), disodium phosphate (Na₂HPO₄, HNa₂PO₄(H₂O)₂, HNa₂PO₄(H₂O)₇, HNa₂PO₄(H₂O)₈ and HNa₂PO₄(H₂O)₁₂), trisodium phosphate (Na₃PO₄, Na₃PO₄(H₂O)_{0.5}, Na₃PO₄(H₂O)₆, Na₃PO₄(H₂O)₈ and Na₃PO₄(H₂O)₁₂), monosodium diphosphate (NaH₃P₂O₇), disodium diphosphate (Na₂H₂P₂O₇ and Na₂H₂P₂O₇(H₂O)₆), trisodium diphosphate (Na₃HP₂O₇, Na₃HP₂O₇(H₂O) and Na₃HP₂O₇(H₂O)₉), tetrasodium diphosphate (Na₄P₂O₇ and Na₄P₂O₇(H₂O)₁₀), and mixtures thereof.

In some aspects, the solid phosphate salt comprises a magnesium phosphate chosen from monomagnesium phosphate ((Mg(H₂PO₄)₂)·xH₂O), dimagnesium phosphate ((MgHPO₄)·xH₂O), trimagnesium phosphate ((Mg₃(PO₄)₂)·xH₂O), ammonium magnesium phosphate (NH₄MgPO₄·6H₂O), and mixtures thereof.

In some aspects, the solid phosphate salt comprises an ammonium phosphate or ammonium polyphosphate chosen from ammonium phosphate ((NH₄)₃PO₄), diammonium phosphate ((NH₄)₂HPO₄), ammonium dihydrogen phosphate ((NH₄)(H₂PO₄)), ammonium polyphosphate ([NH₄ PO₃]ₙ(OH)₂)

In some aspects, the solid phosphate salt comprises iron(III) phosphate (Fe₃(PO₄)₂), aluminum phosphate (AlPO₄), urea phosphate, zinc phosphate (Zn₃(PO₄)₂), or mixtures thereof.

In some aspects, the acid soluble silicate material is configured to react with the reactive phosphate component at a temperature of at least about 250° C., in some aspects at least about 260° C., in some aspects at least about 270° C., in some aspects at least about 280° C., in some aspects at least about 290° C., in some aspects at least about 300° C., in some aspects at least about 310° C., in some aspects at least about 320° C., in some aspects at least about 330° C., in some aspects at least about 340° C., and in some aspects at least about 350° C.

In some aspects, the acid soluble silicate material is configured to react with the reactive phosphate component with minimal heat generation to form the ceramic flame-retardant material. In some aspects, the minimal heat generation is at least greater than 0° C. and up to about 20° C., in some aspects at least 1° C., in some aspects at least 2° C., in some aspects at least 3° C., in some aspects at least 4° C., and in some aspects at least 5° C., and up to about 20° C. In some aspects, the minimal heat generation is greater than 0° C. and less than 20° C., in some aspects less than 19° C., in some aspects less than 18° C., in some aspects less than 17° C., in some aspects less than 16° C., and in some aspects less than 15° C.

In some aspects, the acid soluble silicate material comprises anorthocite (CaAl₂Si₃O₈), wollastonite (CaSiO3), calcined kaolin, or mixtures thereof.

In some aspects, the acid soluble silicate material has a d₅₀ ranging from about 2 microns to about 100 microns, preferably from about 2.5 microns to about 50 microns, and more preferably from about 3 microns to about 15 microns.

In some aspects, a ratio (weight/weight) of the acid soluble silicate material to the solid phosphate salt is between about 4:1 to about 1:4, in some aspects between about 3:1 to about 1:3, in some aspects between about 3:1 and about 1:1.

In some aspects, the acid soluble silicate material is present in the flame-retardant composition in an amount of at least about 2%, in some aspects at least about 3%, in some aspects at least about 4%, in some aspects at least about 5%, in some aspects at least about 6%, in some aspects at least about 7%, in some aspects at least about 8%, in some aspects at least about 9%, and in some aspects at least about 10%, by weight of the total weight of the flame-retardant composition.

In some aspects, the acid soluble silicate material is present in the flame-retardant composition in an amount up to about 50%, in some aspects up to about 45%, in some aspects up to about 40%, in some aspects up to about 35%, in some aspects up to about 30%, in some aspects up to about 25%, in some aspects up to about 20%, and in some aspects up to about 15%, by weight of the total weight of the flame-retardant composition.

In some aspects, the acid soluble silicate material is present in the flame-retardant composition in an amount between about 2% and about 50%, in some aspects between about 2.5% and about 40%, in some aspects between about 5% and about 30%, in some aspects between about 7.5% and about 35%, and in some aspects between about 10% and about 30%, by weight of the total weight of the flame-retardant composition.

In some aspects, the solid phosphate salt is present in the flame-retardant composition in an amount of at least about 2%, in some aspects at least about 3%, in some aspects at least about 4%, in some aspects at least about 5%, in some aspects at least about 6%, in some aspects at least about 7%, in some aspects at least about 8%, in some aspects at least about 9%, and in some aspects at least about 10%, by weight of the total weight of the flame-retardant composition.

In some aspects, the solid phosphate salt is present in the flame-retardant composition in an amount up to about 50%, in some aspects up to about 45%, in some aspects up to about 40%, in some aspects up to about 35%, in some aspects up to about 30%, in some aspects up to about 25%, in some aspects up to about 20%, and in some aspects up to about 15%, by weight of the total weight of the flame-retardant composition.

In some aspects, the solid phosphate salt is present in the flame-retardant composition in an amount between about 2% and about 50%, in some aspects between about 2.5% and about 40%, in some aspects between about 5% and about 30%, in some aspects between about 7.5% and about 35%, and in some aspects between about 10% and about 30%, by weight of the total weight of the flame-retardant composition

In some aspects, the acid soluble silicate material and the solid phosphate salt are present in the flame-retardant composition in an amount of at least about 5%, in some aspects at least about 7%, in some aspects at least about 10%, in some aspects at least about 15%, in some aspects at least about 20%, in some aspects at least about 25%, and in some aspects at least about 30%, by weight of the total weight of the flame-retardant composition

In some aspects, acid soluble silicate material and the solid phosphate salt are present in the flame-retardant composition in an amount up to about 100%, in some aspects up to about 85%, in some aspects up to about 75%, in some aspects up to about 65%, in some aspects up to about 60%, in some aspects up to about 55%, and in some aspects up to about 50%, by weight of the total weight of the flame-retardant composition.

In some aspects, the solid phosphate salt and the acid soluble silicate material are dispersed within the polymer substrate, in some preferred aspects homogenously dispersed within the polymer substrate.

In some aspects, the polymer substrate comprises a polyolefin, polystyrene, polyamide, polyester, polycarbonate, epoxy resins, polyurethane, and copolymers or mixtures thereof.

In some aspects, the solid phosphate salt and the acid soluble silicate material are dispersed within the polymer substrate by high shear mixing.

In some aspects, a melting temperature of the polymer substrate is lower than a melting point or a decomposition point of the solid phosphate salt.

In some aspects, the polymer substrate has a melting temperature of at least 200° C., in some aspects at least 210° C., in some aspects at least 220° C., in some aspects at least 230° C., in some aspects at least 240° C., in some aspects at least 250° C., in some aspects at least 260° C., in some aspects at least 270° C., in some aspects at least 280° C., in some aspects at least 290° C., in some aspects at least 300° C., in some aspects at least 310° C., in some aspects at least 320° C., in some aspects at least 330° C., in some aspects at least 340° C., and in some aspects at least 350° C.

In some aspects, the solid phosphate salt has a melting point of at least about 50° C. above, more preferable at least about 25° C. above, and even more preferable at least about 10° C. above the melting temperature of the polymer substrate.

In some aspects, the solid phosphate salt has a melting point above a temperature of high shear mixing the polymer substrate with the solid phosphate salt and the acid soluble silicate material.

In some aspects, the polymer substrate is present in the flame-retardant composition in an amount of at least about 20%, in some aspects at least about 30%, in some aspects at least about 40%, in some aspects at least about 50%, in some aspects at least about 60%, and in some aspects at least about 70%, by weight of the total weight of the flame-retardant composition.

In some aspects, the polymer substrate is present in the flame-retardant composition in an amount up to about 90%, in some aspects up to about 85%, in some aspects up to about 80%, in some aspects up to about 75%, in some aspects up to about 70%, in some aspects up to about 65%, in some aspects up to about 60%, and in some aspects up to about 55%, by weight of the total weight of the flame-retardant composition.

In some aspects, the polymer substrate is present in the flame-retardant composition in an amount between about 20% and about 90%, in some aspects between about 25% and about 85%, in some aspects between about 30% and about 80%, in some aspects between about 35% and about 75%, and in some aspects between about 40% and about 70%, by weight of the total weight of the flame-retardant composition.

In some aspects, the flame-retardant composition has a flame-retardancy rating equal to or greater than V-2, in some aspects V-1, and in some aspects V-0, when measured according to UL Standard 94.

In some aspects, the solid phosphate salt comprises ammonium polyphosphate, a calcium phosphate salt, a potassium phosphate salt, or a combination thereof, preferably ammonium polyphosphate, and the acid soluble silicate material comprises anorthosite, wollastonite, calcined kaolin, or a combination thereof, preferably anorthosite, wherein the solid phosphate salt melts due to an elevated temperature or flame conditions from a fire to form a reactive phosphate component that reacts in situ with the acid soluble silicate material to form the ceramic flame-retardant material.

In some preferred aspects, the flame-retardant composition forms in situ a ceramic calcium-aluminum-phosphate complex that acts as a non-flammable heat shield.

In some aspects, the flame-retardant composition further comprises a reinforcing material, such as glass fibers.

In some aspects, the flame-retardant composition is substantially halogen free, more preferably completely halogen free.

In some aspects, the flame-retardant composition is substantially free of antimony oxide.

In some preferred aspects, the flame-retardant composition is substantially free of an organic synergist or a nitrogen-based synergist, such that the acid soluble silicate material is an active synergist with the reactive phosphate component.

The above summary is not intended to describe each illustrated embodiment or every implementation of the subject matter hereof. The figures and the detailed description that follow more particularly exemplify various embodiments.

### DETAILED DESCRIPTION

It has been surprisingly discovered that an acid soluble silicate material can be a direct and active synergist with a phosphate component in a liquid or melted form, such that a solid phosphate salt that is non-reactive at ambient temperature with an acid soluble silicate material can form a reactive phosphate component under flame conditions that reacts in situ with the acid soluble silicate material to form a ceramic material having flame-retardant properties.

Without wishing to be bound by theory, it is believed that the solid phosphate salt melts, decomposes and/or otherwise transforms into a reactive phosphate component under an elevated temperature and/or a fire, such as a liquid or melted phosphate and/or phosphoric acid, whereby the reactive phosphate component reacts with the acid soluble silicate material in situ with minimal heat generation to form a ceramic flame-retardant material acting as a ceramic heat-shield that is capable of extinguishing a flame.

The flame-retardant composition is preferably essentially free of an organic and/or nitrogen-based synergist typically used within in the industry to react with a reactive phosphate component, such as a phosphate melt and/or phosphoric acid. Instead, the acid soluble silicate material is a direct or active synergist with the reactive phosphate material.

While it is contemplated that various acids can react with the acid soluble silicate material to form the ceramic fire-resistant material, a reactive phosphate component, whether a phosphate melt and/or phosphoric acid, is the preferred reactive acid component. In preferable aspects of the present invention, the reactive phosphate component is formed from a solid phosphate salt under flame conditions, such as an elevated temperature and/or fire.

In some aspects, the solid phosphate salt comprises one or more sodium phosphate, calcium phosphate, potassium phosphate, ammonium phosphate, magnesium phosphate, polyphosphate, ammonium polyphosphate, pyrophosphate, metaphosphate, or mixtures thereof. The solid phosphate salt can comprise one or more inorganic phosphate-type anion chosen from an orthophosphate anion (PO₄³⁻), a hydrogen phosphate anion (HPO₄²⁻), a dihydrogenphosphate anion (H₂PO₄), a polyphosphate anion (P₂O₇⁴), a triphosphate anion (P₃O₁₀⁵), and mixtures thereof.

In some aspects, the one or more calcium phosphate is chosen from monocalcium phosphate (Ca(H₂PO₄)₂ and Ca(H₂PO₄)₂(H₂O)), dicalcium phosphate (CaHPO₄(H₂O)₂ and CaHPO₄(H₂O)), tricalcium phosphate (Ca₃(PO₄)₂), octacalcium phosphate (Ca₈H₂(PO₄)₆·5H₂O), dicalcium diphosphate (Ca₂P₂O₇), calcium triphosphate (Ca₅(P₃O₁₀)₂), hydroxyapatite (Ca₅(PO₄)₃(OH)), apatite (Ca₁₀(PO₄)₆(OH,F,Cl,Br)₂), tetracalcium phosphate (Ca₄(PO₄)₂O), and mixtures thereof.

In some aspects, the one or more potassium phosphate is chosen from monopotassium phosphate (KH₂PO₄), dipotassium phosphate (K₂HPO₄), tripotassium phosphate (K₃PO₄), and mixtures thereof.

In some aspects, the one or more sodium phosphate is chosen from monosodium phosphate (NaH₂PO₄, NaH₂PO₄(H₂O) and NaH₂PO₄(H₂O)₂), disodium phosphate (Na₂HPO₄, HNa₂PO₄(H₂O)₂, HNa₂PO₄(H₂O)₇, HNa₂PO₄(H₂O)₈ and HNa₂PO₄(H₂O)₁₂), trisodium phosphate (Na₃PO₄, Na₃PO₄(H₂O)_{0.5}, Na₃PO₄(H₂O)₆, Na₃PO₄(H₂O)₈ and Na₃PO₄(H₂O)₁₂), monosodium diphosphate (NaH₃P₂O₇), disodium diphosphate (Na₂H₂P₂O₇ and Na₂H₂P₂O₇(H₂O)₆), trisodium diphosphate (Na₃HP₂O₇, Na₃HP₂O₇(H₂O) and Na₃HP₂O₇(H₂O)₉), tetrasodium diphosphate (Na₄P₂O₇ and Na₄P₂O₇(H₂O)₁₀), and mixtures thereof.

In some aspects, the one or more magnesium phosphate is chosen from monomagnesium phosphate ((Mg(H₂PO₄)₂)·xH₂O), dimagnesium phosphate ((MgHPO₄)·xH₂O), trimagnesium phosphate ((Mg₃(PO₄)₂)·xH₂O), ammonium magnesium phosphate (NH₄MgPO₄·6H₂O), and mixtures thereof.

In some aspects, an ammonium phosphate and/or ammonium polyphosphate is chosen from ammonium phosphate ((NH₄)₃PO₄), diammonium phosphate ((NH₄)₂HPO₄), ammonium dihydrogen phosphate ((NH₄)(H₂PO₄)), ammonium polyphosphate ([NH₄ PO₃]ₙ(OH)₂), and mixtures thereof.

In some aspects, the solid phosphate salt comprises iron(III) phosphate (Fe₃(PO₄)₂), aluminum phosphate (AlPO₄), urea phosphate, zinc phosphate (Zn₃(PO₄)₂), or mixtures thereof, individually or in combination with one or more of the foregoing solid phosphate salts.

In some preferred aspects, the solid phosphate salt comprises ammonium polyphosphate, potassium phosphate, calcium phosphate, or a mixture thereof.

The solid phosphate salt in the flame-retardant composition can depend upon the desired melting temperature to form the reactive phosphate component. For instance, ammonium polyphosphate has a melting point between about 240° C. and about 275° C., such that it is believed that ammonium polyphosphate starts to decompose at the melting point to form ammonia and the reactive phosphate component, such as phosphoric acid and/or a melted phosphate. Monopotassium phosphate has a melting point of about 252° C., dipotassium phosphate has a melting point greater than about 465° C., such that the flame conditions for these particular solid potassium phosphates need to reach a higher temperature than that of ammonium polyphosphate before the reactive phosphate component is formed.

In some aspects, the solid phosphate salt in the flame-retardant composition can depend upon whether the solid phosphate salt and the acid soluble silicate material are dispersed within a polymer substrate, such as by high shear mixing, such that the desired melting temperature of the solid phosphate salt is greater than the melt processing temperature to avoid the solid phosphate salt transforming into the reactive phosphate component during processing.

The flame-retardant composition can be configured such that the acid soluble silicate material and the reactive phosphate component provided from the solid phosphate salt react to form the ceramic flame-retardant material at a desired elevated temperature, such as wherein the desired elevated temperature is at least about 250° C., in some aspects at least about 260° C., in some aspects at least about 270° C., in some aspects at least about 280° C., in some aspects at least about 290° C., in some aspects at least about 300° C., in some aspects at least about 310° C., in some aspects at least about 320° C., in some aspects at least about 330° C., in some aspects at least about 340° C., and in some aspects at least about 350° C.

The flame-retardant composition is preferably configured such that the acid soluble silicate material reacts with the reactive phosphate component with minimal heat generation to form the ceramic flame-retardant material. In some preferred aspects, the flame-retardant composition has minimal amounts of carbonate minerals and/or oxides that would provide exothermic reactions that are not effective as flame-retardant materials.

In some aspects, the minimal heat generation is at least greater than 0° C. and up to about 20° C., in some aspects between about 1° C. and about 20° C., in some aspects between about 2° C. and about 20° C., in some aspects between about 3° C. and about 20° C., in some aspects between about 4° C. and about 20° C., and in some aspects between about 5° C. and about 20° C. In some other aspects, the minimal heat generation is between about 1° C. and about 19° C., in some aspects between about 2° C. and about 18° C., in some aspects between about 3° C. and about 17° C., in some aspects between about 4° C. and about 16° C., and in some aspects between about 5° C. and about 15° C. In some aspects, the minimal heat generation is at least 1° C., in some aspects at least 2° C., in some aspects at least 3° C., in some aspects at least 4° C., and in some aspects at least 5° C. In some aspects, the minimal heat generation is less than 25° C., in some aspect less than 20° C., in some aspects less than 19° C., in some aspects less than 18° C., in some aspects less than 17° C., in some aspects less than 16° C., in some aspects less than 15° C., and in some aspects less than 10° C.

In some aspects, the acid soluble silicate material comprises anorthocite (CaAl₂Si₃O₈), wollastonite (CaSiO3), calcined kaolin, or mixtures thereof. In some preferred aspects, the acid soluble silicate material comprises anorthocite (CaAl₂Si₃O₈), wollastonite (CaSiO₃), or mixtures thereof. In some more preferred aspects, the acid soluble silicate material comprises anorthocite (CaAl₂Si₃O₈).

The acid soluble silicate material preferably has a d₅₀ ranging from about 2 microns to about 100 microns, preferably from about 2.5 microns to about 50 microns, and more preferably from about 3 microns to about 15 microns. In some preferred aspects, the acid soluble silicate material comprises anorthocite (CaAl₂Si₃O₈) having a d₅₀ ranging from about 2 microns to about 100 microns, preferably from about 2.5 microns to about 50 microns, and more preferably from about 3 microns to about 15 microns. In some aspects, the acid soluble silicate material may need to be processed to provide a preferred particle size, such as to optimize the reaction with the reactive phosphate component.

A ratio (weight/weight) of the acid soluble silicate material to the solid phosphate salt is preferably between about 4:1 to about 1:4, in some other preferable aspects between about 3:1 to about 1:3, in some other preferable aspects between about 3:1 and about 1:1.

The acid soluble silicate material can be present in the flame-retardant composition in an amount of at least about 2%, in some aspects at least about 3%, in some aspects at least about 4%, in some aspects at least about 5%, in some aspects at least about 6%, in some aspects at least about 7%, in some aspects at least about 8%, in some aspects at least about 9%, and in some aspects at least about 10%, by weight of the total weight of the flame-retardant composition.

The acid soluble silicate material can be present in the flame-retardant composition in an amount up to about 50%, in some aspects up to about 45%, in some aspects up to about 40%, in some aspects up to about 35%, in some aspects up to about 30%, in some aspects up to about 25%, in some aspects up to about 20%, and in some aspects up to about 15%, by weight of the total weight of the flame-retardant composition.

The acid soluble silicate material can be present in the flame-retardant composition in an amount between about 2% and about 50%, in some aspects between about 2.5% and about 40%, in some aspects between about 5% and about 30%, in some aspects between about 7.5% and about 35%, and in some aspects between about 10% and about 30%, by weight of the total weight of the flame-retardant composition.

The solid phosphate salt can be present in the flame-retardant composition in an amount of at least about 2%, in some aspects at least about 3%, in some aspects at least about 4%, in some aspects at least about 5%, in some aspects at least about 6%, in some aspects at least about 7%, in some aspects at least about 8%, in some aspects at least about 9%, and in some aspects at least about 10%, by weight of the total weight of the flame-retardant composition.

The solid phosphate salt can be present in the flame-retardant composition in an amount up to about 50%, in some aspects up to about 45%, in some aspects up to about 40%, in some aspects up to about 35%, in some aspects up to about 30%, in some aspects up to about 25%, in some aspects up to about 20%, and in some aspects up to about 15%, by weight of the total weight of the flame-retardant composition.

The solid phosphate salt can be present in the flame-retardant composition in an amount between about 2% and about 50%, in some aspects between about 2.5% and about 40%, in some aspects between about 5% and about 30%, in some aspects between about 7.5% and about 35%, and in some aspects between about 10% and about 30%, by weight of the total weight of the flame-retardant composition

The acid soluble silicate material and the solid phosphate salt can be present in the flame-retardant composition in an amount of at least about 5%, in some aspects at least about 7%, in some aspects at least about 10%, in some aspects at least about 15%, in some aspects at least about 20%, in some aspects at least about 25%, and in some aspects at least about 30%, by weight of the total weight of the flame-retardant composition

The acid soluble silicate material and the solid phosphate salt can be present in the flame-retardant composition in an amount up to about 100%, in some aspects up to about 85%, in some aspects up to about 75%, in some aspects up to about 65%, in some aspects up to about 60%, in some aspects up to about 55%, and in some aspects up to about 50%, by weight of the total weight of the flame-retardant composition.

In some preferred aspects, the solid phosphate salt and the acid soluble silicate material are dispersed within a polymer substrate, in some preferred aspects homogenously dispersed within the polymer substrate. In some aspects, the solid phosphate salt and the acid soluble silicate material are dispersed within the polymer substrate by high shear mixing. A melting temperature of the polymer substrate is preferably lower than a melting point or a decomposition point of the solid phosphate salt, such that the solid phosphate salt does not transform into the reactive phosphate component during processing or dispersal within the substrate polymer.

The polymer substrate may comprise any wide variety of polymeric types, including polyolefins, polystyrene, polyamide, polyester, polycarbonate, epoxy resins, polyurethane, and copolymers (e.g., random or block copolymers) or mixtures thereof. For example, the polymer substrate may be selected from the group of resins consisting of polyolefins, thermoplastic olefins, styrenic polymers or copolymers, acrylonitrile-butadiene-styrene (ABS), polyamides and polymers which contain hetero atoms, double bonds or aromatic rings. Specific embodiments are where the thermoplastic polymer is polypropylene, polyethylene, thermoplastic olefin (TPO), ABS, high impact polystyrene or polyethylene terephthalate or polyimide.

In some aspects, the polymer substrate is selected from the group of resins consisting of polyolefins, thermoplastic olefins, styrenic polymers or copolymers, ABS, polyesters, polyamides, polycarbonates and blends thereof.

In some other aspects, the polymer substrate is selected from the group consisting of polypropylene, polyethylene, TPO, ABS, high impact polystyrene, polycarbonate and polyethylene terephthalate.

The polymer substrate may also be thermoplastic polyurethane, thermoplastic elastomer, polymethylmethacrylate, rubbers, polyesters, polyacrylonitrile or polyoxymethylene.

In some preferred aspects, the polymer substrate is a polyolefin-based substrate, such as polypropylene (PP), polyethylene (PE), polybutylene, or co-polymers thereof. The term “polyolefin-based substrate” means a substrate containing one or more polyolefins, such as polyolefin homopolymers and polyolefin copolymers.

In some other preferred aspects, the polymer substrate is a thermoplastic olefin (TPO). The thermoplastic polymer is more preferably a polyolefin like polyethylene, polypropylene or copolymers thereof. The thermoplastic polymer is most preferably polypropylene (PP). Polyethylene is preferably linear low density (LLDPE), low density (LDPE) or high density (HDPE). Mixtures of polypropylene with polyethylene are suitable substrates, for example PP/HDPE, PP/LDPE and mixtures of different types of polyethylene (for example LDPE/HDPE). Ethylene/propylene copolymers are also suitable substrates (polypropylene/polyethylene copolymers).

TPOs are for instance blends of polypropylene homopolymers and impact modifiers such as EPDM or ethylene/alpha-olefin copolymers. TPO is for example about 10 to about 90 parts propylene homopolymer, copolymer or terpolymer, and about 90 to about 10 parts (by weight) of an elastomeric copolymer of ethylene and a C₃-C₈ alpha-olefin. The elastomeric copolymer is for instance ethylene/propylene copolymer (EPM) or ethylene/propylene/non-conjugated diene (EPDM).

In certain aspects, the polyolefin substrate comprises one or more a-olefin polymers, such as low density polyethylene (LDPE), linear low density polyethylene (LLDPE), high density polyethylene (HDPE), medium density polyethylene (MDPE), isotactic polypropylene, syndiotactic polypropylene, hemiisotactic polypropylene, polybutene, cycloolefin polymers, stereoblock polypropylene, poly-3-methyl-1-butene, poly-3-methyl-1-pentene, and poly-4-methyl-1-pentene, and a-olefin copolymers such as ethylene/propylene block or random copolymers, ethylene-methyl methacrylate copolymers, ethylene-vinyl acetate copolymers, and mixtures thereof. Certain embodiments of polymer mixtures include, for example, PP/HDPE, PP/LLDPE, and LLDPE/HDPE as well as ternary mixtures such as PP/HDPE/LLDPE. In certain embodiments, polymers can be linear or branched and can be formulated with or without crosslinking (e.g., chemical crosslinking).

The polyolefin substrate may have other polymers incorporated therein, including polystyrene, polyamide, polyester, polycarbonate, epoxy resins, polyurethane, and copolymers (e.g., random or block copolymers) or mixtures thereof.

In some aspects, the polymer substrate comprises at least one polyamide polymer or polyamide oligomer. Suitable polyamides for both the polyamide polymer and polyamide oligomer are all the polyamides known to a person skilled in the art, comprising crystalline, semi-crystalline and amorphous polyamides, that are melt-processable. Examples of suitable polyamides according to the invention are aliphatic polyamides, for example PA-6, PA-11, PA-12, PA4,6, PA-4,8, PA-4,10, PA-4,12, PA-6,6, PA-6,9, PA-6,10, PA-6,12, PA-10,10, PA-12,12, PA-6/6,6-copolyamide, PA-6/12-copolyamide, PA-6/11-copolyamide, PA-6,6/11-copolyamide, PA-6,6/12-copolyamide, PA-6/6, 10-copolyamide, PA-6,6/6, 10-copolyamide, PA-4,6/6-copolyamide, PA-6/6,6/6, 10-terpolyamide, and copolyamides obtained from 1,4-cyclohexanedicarboxylic acid and 2,2,4- and 2,4,4-trimethylhexamethylenediamine, aromatic polyamides, for example PA-6,I, PA-6,I/6,6-copolyamide, PA-6,T, PA-6,T/6-copolyamide, PA-6,T/6,6-copolyamide, PA-6,1/6,T-copolyamide, PA-6,6/6, T/6,I-copolyamide, PA-6,T/2-MPMDT-copolyamide (MPMDT=2-methylpentamethylene diamine), PA-9,T, copolyamides obtained from terephthalic acid, 2,2,4- and 2,4,4-trimethylhexamethylenediamine, copolyamide obtained from isophthalic acid, laurinlactam and 3,5-dimethyl-4,4-diamino-dicyclohexylmethane, copolyamides obtained from isophthalic acid, azelaic acid and/or sebacic acid and 4,4-diaminodicyclohexylmethane, copolyamides obtained from caprolactam, isophthalic acid and/or terephthalic acid and 4,4-diaminodicyclohexyl-methane, copolyamides obtained from caprolactam, isophthalic acid and/or terephthalic acid and isophoronediamine, copolyamides obtained from isophthalic acid and/or terephthalic acid and/or other aromatic or aliphatic dicarboxylic acids, optionally alkyl-substituted hexamethylenediamine and alkyl-substituted 4,4-diaminodicyclohexylamine, and also copolyamides and mixtures of the aforementioned polyamides.

Preferably polyamides are chosen from the group comprising PA-6, PA-6,6, PA-6,10, PA-4,6, PA-11, PA-12, PA-12,12, PA-6,I, PA-6,T, PA-6,T/6,6-copolyamide, PA-6,T/6-copolyamide, PA-6/6,6-copolyamide, PA-6,6/6,T/6,I-copolyamide, PA-6,T/2-MPMDT-copolyamide, PA-9,T, PA-4,6/6-copolyamide and mixtures and copolyamides of the aforementioned polyamides. More preferably PA-6,I, PA-6,T, PA-6,6, PA-6,6/6T, PA-6,6/6,T/6,I-copolyamide, PA-6,T/2-MPMDT-copolyamide, PA-9,T or PA-4,6, or a mixture or copolyamide thereof, is chosen as the polyamide.

In some preferred aspects, the solid phosphate salt and the acid soluble silicate material components are dispersed within the suitable polymer substrate by high shear mixing, such a melting temperature of the polymer substrate is lower than a melting point of the solid phosphate salt.

The polymer substrate can have a melting temperature of at least 200° C., in some aspects at least 210° C., in some aspects at least 220° C., in some aspects at least 230° C., in some aspects at least 240° C., in some aspects at least 250° C., in some aspects at least 260° C., in some aspects at least 270° C., in some aspects at least 280° C., in some aspects at least 290° C., in some aspects at least 300° C., in some aspects at least 310° C., in some aspects at least 320° C., in some aspects at least 330° C., in some aspects at least 340° C., and in some aspects at least 350° C.

In some preferred aspects, the solid phosphate salt has a melting point of at least about 50° C. above, more preferable at least about 25° C. above, and even more preferable at least about 10° C. above the melting temperature of the polymer substrate. The advantage of a solid phosphate salt having a melting point that is greater than the melting temperature of the polymer substrate is that the solid phosphate salt does not melt during melt processing of the polymer substrate and dispersal of the solid phosphate salt and the acid soluble silicate material.

The polymer substrate can be present in the flame-retardant composition in an amount of at least about 20%, in some aspects at least about 30%, in some aspects at least about 40%, in some aspects at least about 50%, in some aspects at least about 60%, and in some aspects at least about 70%, by weight of the total weight of the flame-retardant composition.

The polymer substrate can be present in the flame-retardant composition in an amount up to about 90%, in some aspects up to about 85%, in some aspects up to about 80%, in some aspects up to about 75%, in some aspects up to about 70%, in some aspects up to about 65%, in some aspects up to about 60%, and in some aspects up to about 55%, by weight of the total weight of the flame-retardant composition.

The polymer substrate can be present in the flame-retardant composition in an amount between about 20% and about 90%, in some aspects between about 25% and about 85%, in some aspects between about 30% and about 80%, in some aspects between about 35% and about 75%, and in some aspects between about 40% and about 70%, by weight of the total weight of the flame-retardant composition.

The flame-retardant composition preferably has a flame-retardancy rating equal to or greater than V-2, in some aspects V-1, and in some aspects V-0, when measured according to UL Standard 94.

In some aspects, the solid phosphate salt comprises ammonium polyphosphate, a calcium phosphate salt, a potassium phosphate salt, or a combination thereof, preferably ammonium polyphosphate, and the acid soluble silicate material comprises anorthosite, wollastonite, calcined kaolin, or a combination thereof, preferably anorthosite, wherein the solid phosphate salt melts due to an elevated temperature or flame conditions from a fire to form a reactive phosphate component that reacts in situ with the acid soluble silicate material to form the ceramic flame-retardant material.

In some preferred aspects, the flame-retardant composition forms in situ a ceramic calcium-aluminum-phosphate complex that acts as a non-flammable heat shield.

In some aspects, the flame-retardant composition further comprises a reinforcing material, such as glass fibers.

In some aspects, the flame-retardant composition is substantially halogen free, more preferably completely halogen free.

In some aspects, the flame-retardant composition is substantially free of antimony oxide.

In some preferred aspects, the flame-retardant composition is substantially free of an organic synergist or a nitrogen-based synergist, such that the acid soluble silicate material is an active synergist with the reactive phosphate component.

The present disclosure is also directed to a method of manufacturing the flame-retardant composition. In some preferred aspects, each of the solid phosphate salt and acid soluble silicate material are provided together, and preferably mixed together. The solid phosphate salt and the acid soluble silicate material are preferably mixed by melt processing or by high shear mixing. A polymer substrate can be present, and in some preferred aspects, the flame-retardant composition has the polymer substrate present. Melt processing and high shear mixing the solid phosphate salt, the acid soluble silicate material, and the optional polymer substrate mixes the solid phosphate salt and the acid soluble silicate material, and preferably disperses the solid phosphate salt and the acid soluble silicate material within the polymer substrate.

The flame-retardant composition can then be utilized to manufacture various articles of manufacture, such as a plastic article, preferably a sheet of material. The flame-retardant composition can also be used in a paint formulate or an intumescent coating.

The flame-retardant composition is configured to form the ceramic flame-retardant material in situ to provide a thermal insulation barrier by decomposing the solid phosphate salt at a desired temperature into the reactive phosphate component, and reacting the reactive phosphate component with the acid soluble silicate material to form the ceramic flame-retardant material. The flame-retardant composition is preferably integrated into an article of manufacture, such that the article has flame-retardant properties.

When the article of manufacture has the flame-retardant composition, the article of manufacture is configured to form the ceramic flame-retardant material in situ when exposed to the elevated temperature, preferably a fire, to provide the thermal insulation barrier resulting from the solid phosphate salt being decomposed into the reactive phosphate component and having reacted with the acid soluble silicate material in situ to form the ceramic flame-retardant material.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A flame-retardant composition comprising:
a solid phosphate salt;
an acid soluble silicate material comprising anorthocite (CaAl₂Si₃O₈); and
an optional polymer substrate;
wherein the solid phosphate salt is configured to decompose into a reactive phosphate component at a desired temperature as a result of an elevated temperature or fire, and wherein the reactive phosphate component is capable of reacting with the acid soluble silicate material in situ to form a ceramic flame-retardant material providing a thermal insulation barrier.

2. The flame-retardant composition of claim 1, wherein the solid phosphate salt comprises one or more inorganic phosphate-type anions chosen from an orthophosphate anion (PO₄³⁻), a hydrogen phosphate anion (HPO₄²⁻), a dihydrogenphosphate anion (H₂PO₄⁻), a polyphosphate anion (P₂O₇⁴), a triphosphate anion (P₃O₁₀⁵), and mixtures thereof.

3. The flame-retardant composition of claim 2, wherein the solid phosphate salt comprises a sodium phosphate, a calcium phosphate, a potassium phosphate, an ammonium phosphate, a magnesium phosphate, a polyphosphate, an ammonium polyphosphate, a trisodium polyphosphate, a pyrophosphate, a metaphosphate, and mixtures thereof.

4-9. (canceled)

10. The flame-retardant composition of claim 3, wherein the acid soluble silicate material is configured to react with the reactive phosphate component at the desired temperature of at least 250° C.

11. The flame-retardant composition of claim 1, wherein the acid soluble silicate material is configured to react with the reactive phosphate component with minimal heat generation of less than 20° C. to form the ceramic flame-retardant material.

12. The flame-retardant composition of claim 1, wherein the acid soluble silicate material futher comprises wollastonite (CaSiO₃), calcined kaolin, and mixtures thereof.

13. The flame-retardant composition of claim 1, wherein the acid soluble silicate material has a d₅₀ ranging from about 3 microns to about 15 microns.

14-16. (canceled)

17. The flame-retardant composition of claim 1, wherein the acid soluble silicate material is present in the flame-retardant composition in an amount between about 10% and about 30%, by weight of the total weight of the flame-retardant composition

18-19. (canceled)

20. The flame-retardant composition of claim 17, wherein the solid phosphate salt is present in the flame-retardant composition in an amount between about 10% and about 30%, by weight of the total weight of the flame-retardant composition

21. The flame-retardant composition of claim 20, wherein the acid soluble silicate material and the solid phosphate salt are present in the flame-retardant composition in an amount of at least about 20%, and up to about 100%, by weight of the total weight of the flame-retardant composition

22-24. (canceled)

25. The flame-retardant composition of claim 1, further comprising the polymer substrate, wherein the solid phosphate salt and the acid soluble silicate material are homogenously dispersed within the polymer substrate, and wherein the polymer substrate comprises a polyolefin, polystyrene, polyamide, polyester, polycarbonate, epoxy resins, polyurethane, and copolymers or mixtures thereof.

26. The flame-retardant composition of claim 25, wherein the solid phosphate salt and the acid soluble silicate material are homogeneously dispersed within the polymer substrate by high shear mixing.

27. The flame-retardant composition of claim 25, wherein a melting temperature of the polymer substrate is lower than a melting point or a decomposition point of the solid phosphate salt.

28. (canceled)

29. The flame-retardant composition of claim 27, wherein the solid phosphate salt has a melting point of at least about 10° C. above the melting temperature of the polymer substrate.

30-32. (canceled)

33. The flame-retardant composition of claim 29, wherein the polymer substrate is present in the flame-retardant composition in an amount between about 40% and about 70%, by weight of the total weight of the flame-retardant composition.

34. (canceled)

35. The flame-retardant composition of claim 1, wherein the flame-retardant composition is provided in an article of manufacture, a paint formula, or an intumescent coating.

36. (canceled)

37. The flame-retardant composition of claim 1, wherein the flame-retardant composition is substantially halogen free, substantially free of antimony oxide, substantially free of an organic synergist, and substantially free of a nitrogen-based synergist. 17

38-40. (canceled)

41. A method of manufacturing a flame-retardant composition, the method comprising:
providing a solid phosphate salt;
providing a acid soluble silicate material comprising anorthocite (CaAl₂Si₃O₈);
providing a polymer substrate; and
high shear mixing the solid phosphate salt, the acid soluble silicate material, and the polymer substrate to mix disperse the solid phosphate salt and the acid soluble silicate material within the polymer substrate.

42. A method of forming the ceramic flame-retardant material in situ to provide the thermal insulation barrier of claim 1, the method comprising:
providing the flame-retardant composition of any of claims 1 to 39, preferably manufactured by the method of claim 41;
decomposing the solid phosphate salt at a desired temperature into a reactive phosphate component; and
reacting the reactive phosphate component with the acid soluble silicate material to form the ceramic flame-retardant material.

43. A method of manufacturing an article having flame-retardant properties, the method comprising:
providing a flame-retardant composition comprising:
a solid phosphate salt;
an acid soluble silicate material comprising anorthocite (CaAl₂Si₃O₈); and
an optional polymer substrate;
wherein the solid phosphate salt is configured to decompose into a reactive phosphate component at a desired temperature as a result of an elevated temperature or fire, and wherein the reactive phosphate component is capable of reacting with the acid soluble silicate material in situ to form a ceramic flame-retardant material providing a thermal insulation barrier; and
forming an article comprising the flame-retardant composition.

44-46. (canceled)
